(19) United States
(12) Patent Application Publication
(10) Pub. No.: US 2008/0317906 A1
(43) Pub. Date: Dec. 25, 2008

(54) Beverage bottle and a method of operating the same

(76) Inventor: Tim Goldburt, Ardsley, NY (US)

Correspondence Address: IIya Zborovsky, 6 Schoolhouse Way, Dix Hills, NY, 11746, US

(21) Appl. No.: 11/821,334

(22) Filed: Jun. 22, 2007

(51) Int. Cl. A23L 1/025; A23L 1/03; A23L 1/48

(52) U.S. Cl. 426/87; 426/132; 426/234; 426/237

(57) ABSTRACT

A beverage bottle has a container, a beverage accommodated in the container, the beverage including a light-sensitive additive which has an original color and under the action of radiation, changes its original color to a different color, and a device associated with the container and configured to generate a radiation which acts on the additive and to change the original color of the additive and therefore of the beverage to a different color.

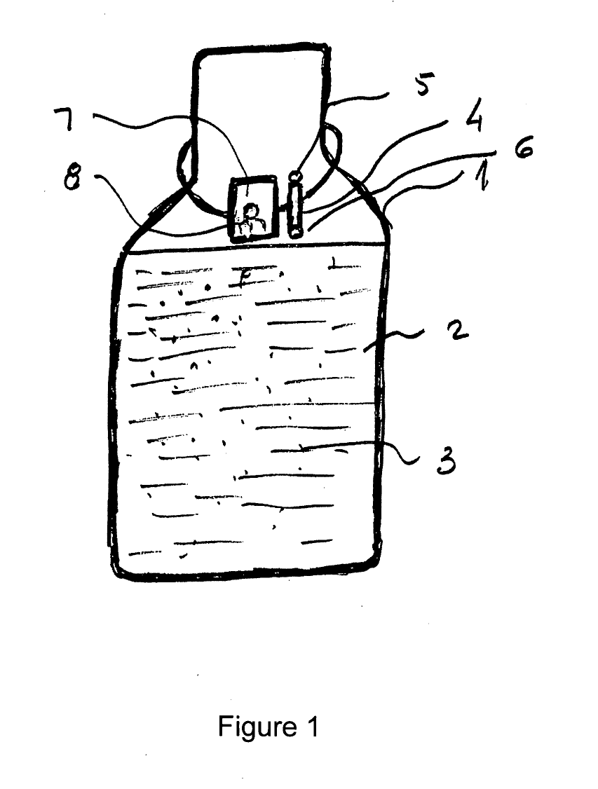

### BACKGROUND OF THE INVENTION

The present invention relates to beverage bottles, or in other words to bottles which accommodate alcoholic or non alcoholic beverages. The term “bottle” is used here in general to identify any container which contains an alcoholic beverage or a non-alcoholic beverage.

Bottles for accommodating alcoholic and non alcoholic beverages are known in the art. Usually, they include a container and a beverage which is accommodated in it. The existing beverage bottles contain the beverages which generally maintain their original color that they obtain during the manufacture. It is believed that the conventional beverage bottles can be further improved.

### SUMMARY OF THE INVENTION

Accordingly, it is an object of the present invention to provide a beverage bottle and a method of operating the same, which is a further improvement of the existing solutions of this type.

In keeping with these objects and with others which will become apparent hereinafter, one feature of the present invention resides, briefly stated, in a beverage bottle, comprising a container; a beverage accommodated in said container, said beverage including a radiation-sensitive additive which has an original color and under the action of radiation, changes its original color to a different color; and a device associated with said container and configured to generate a radiation which acts on, said radiation-sensitive additive and thereby changes the original color of the additive and thereby of the beverage to a different color.

Another feature of the present invention resides, briefly stated, in that said additive is an additive which has luminescent properties, and said device is configured as a device which generates a radiation that causes luminescence of the additive.

A further feature of the present invention resides, briefly stated, in an element associated with said container and carrying an image which is originally invisible, and under the action of radiation by said device becomes visible.

A further feature of the present invention resides, briefly stated, in that said container has a neck area, said device being attached to said neck area.

A further feature of the present invention resides, briefly stated, in a method of operating a beverage bottle, comprising accommodating a beverage in a container, said beverage including a radiation-sensitive additive which has an original color and under the action of a radiation, changes its original color to a different color; and generating by a device associated with said container a radiation which acts on said radiation-sensitive additive and thereby changes the original color of the additive and thereby beverage to a different color.

The novel features of which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing a beverage bottle in accordance with the present invention.

### DESCRIPTION OF THE PREFERRED EMBODIMENTS

A beverage bottle in accordance with the present invention has a container element which is identified with reference numeral 1.

The container element 1 accommodates a beverage which is identified with reference numeral 2. The beverage 2 can be an alcoholic beverage or a non-alcoholic beverage.

In accordance with the present invention, the beverage 2 which is accommodated in the container element 1 has an additive or additives identified schematically with reference numeral 3. It is to be understood that the illustration of the additives is of purely relative nature, since the additives can be dissolved in the beverage so that they are not seen, for example dissolved on a molecular level.

The additives 3 are of such nature that they are sensitive to radiation, so that when they are subjected to a radiation the color of the additive 3 changes and thereby the color of the beverage 2 changes from its original color to a different color.

For example, the additives are such that originally the can be colorless, and when subjected to radiation assumes a certain color. Or the additive 3 can be such that the additive 3 can have a certain original color, but when subjected to radiation it assumes a color which is different from the original color. The additive 3 can be a luminescent additive which under the action of radiation produces luminescence.

The additives can be sensitive for example to UV radiation or blue light radiation, so that under the action of the UV radiation or blue light radiation they change their color.

The beverage bottle further has a device which generates a radiation that acts on the additive 3 so that the color of the additive 3 and thereby of the beverage 2 changes from an original color to a different color. The device 4 can be formed as a necker which for example, is attached to a neck of the container 1. When the device 4 operates it acts on the additive 3 with radiation and causes change of the original color of the additive and thereby of the beverage 2 to a different color.

The device 4 has a power source for example a battery, and is provided with an activation button or a similar activation member which is identified with reference numeral 5. It is also provided with an emitting member 6 formed, for example as a light emitting diode.

When the button 5 is activated, the light emitting diode 6 emits the light, for example blue or UV light.

It is to be understood that when in this application it is stated that the color of the additive 3 and thereby of the beverage 2 in which it is accommodated changes from its original color to a different color, in actuality the color of the additive 3 dissolved in the beverage 2 changes and therefore it looks like the color of the beverage 2 itself changes, or the additive 3 emits a light which changes the color of the beverage from the original color to the different color.

In the beverage bottle an element 7 can be provided, which carries an image 8. The image 8 is originally invisible for example printed with the use of a luminescent ink, but under the action of the above-mentioned radiation becomes visible. The element 7 can be formed as a tag, and the image 8 can be a text, a photo or the like. The element 7 can be attached to the necker, or place on any other location of the bottle, for example glued to it.

It will be understood that each of the elements described above, or two or more together, may also find a useful application in other types of constructions differing from the type described above.

While the invention has been illustrated and described as embodied in a beverage container and a method of operating the same, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A beverage bottle, comprising a container; a beverage accommodated in said container, said beverage including a radiation-sensitive additive which has an original color and under the action of radiation, changes its original color to a different color; and a device associated with said container and configured to generate a radiation which acts on said additive and thereby changes the original color of the additive and therefore of the beverage to a different color.

2. A beverage bottle as defined in claim 1, wherein said additive is a luminescence producing additive, said device being configured as a device which generates a radiation causing luminescing of said additive.

3. A beverage bottle as defined in claim 1, further comprising an element associated with said container and carrying an image which is originally invisible, and under the action of radiation by said device becomes visible.

4. A beverage bottle as defined in claim 1, wherein said container has a neck area, said device being attached to said neck area.

5. A method of operating of a beverage container, comprising the steps of accommodating a beverage in a container, said beverage including a radiation sensitive additive which has an original color and under the action of radiations, changes its original color to a different color; and generating by a device associated with said container radiation which acts on said additive and thereby changes the original color of the additive and thereby of the beverage to a different color.

6. A method as defined in claim 5, wherein said additive is an additive producing luminescence, said device generating radiation which causes the luminescence of the said additive.

7. A method as defined in claim 5, further comprising associating an image element with said container that carries an image which is originally invisible, and acting by the radiation generated by said device on the image element so that the image becomes visible.

8. A method as defined in claim 1, further comprising attaching said device to a neck area of the container.
